(19) United States
(12) Patent Application Publication
(10) Pub. No.: US 2015/0381278 A1
(43) Pub. Date: Dec. 31, 2015

(54) LOW-PROFILE OPTICAL TRANSCEIVER SYSTEM WITH TOP AND BOTTOM LENSES

(71) Applicant: Avago Technologies General IP (Singapore) Pte. Ltd., Singapore (SG)

(72) Inventors: David J.K. Meadowcroft, San Jose, CA (US); Paul Yu, Sunnyvale, CA (US)

(21) Appl. No.: 14/316,999

(22) Filed: Jun. 27, 2014

(51) Int. Cl. H04B 10/40; H04B 10/25; G01J 1/04

(52) U.S. Cl. CPC H04B 10/40; G01J 1/0411; H04B 10/2504

(57) ABSTRACT

An optical communications module includes a module housing, a printed circuit board (PCB), a device mounting block, at least one opto-electronic device, at least one signal processing integrated circuit (IC), and a top lens device. The opto-electronic device is mounted on the device mounting block. An upper surface of the signal processing IC has a signal contact array in electrical contact with a corresponding signal pad array on the PCB lower surface. The top lens device has a fiber port configured to communicate optical signals with a fiber-optic cable at the forward end of the module housing, a device port configured to communicate the optical signals with the opto-electronic device, and a reflector portion configured to redirect the optical signals at a non-zero angle between the fiber port and the device port.

### BACKGROUND

Optical data transceiver modules convert optical signals received via an optical fiber into electrical signals, and convert electrical signals into optical signals for transmission via an optical fiber. In the transmitter portion of a transceiver module, an opto-electronic light source such as a laser performs the electrical-to-optical signal conversion. In the receiver portion of the transceiver module, an opto-electronic light detector such as a photodiode performs the optical-to-electrical signal conversion. A transceiver module commonly also includes optical elements or optics, such as lenses, as well as electrical circuitry such as drivers and receivers. A transceiver module also includes one or more fiber ports to which an optical fiber cable is connected. The light source, light detector, optical elements and electrical circuitry are mounted within a module housing. The one or more fiber ports are located on the module housing.

Various transceiver module configurations are known. One type of transceiver module configuration is known as Small Form Factor Pluggable (SFP). Such SFP transceiver modules include an elongated housing having a substantially rectangular cross-sectional shape. A forward end of the housing is connectable to a fiber-optic cable. A rearward end of the housing has an array of electrical contacts that can be plugged into a mating connector when the rearward end is inserted or plugged into a slot of a network switch or other device.

In some transceiver modules, the opto-electronic devices (i.e., light source and light detector) are mounted on a printed circuit board (PCB) with their optical axes normal to the plane of the PCB. As these device optical axes are perpendicular to the ends of the optical fibers, there is a need to redirect or “turn” the signal path 90 degrees between the fibers and the device optical axes. In some transceiver modules, a 90-degree signal path turn is accomplished in the electrical domain by, for example, a flex circuit. In other transceiver modules, the turn is accomplished in the optical domain by a reflective surface included in the optics. The optics may also include multiple lenses. A transceiver module having a complex optics arrangement may be taller, i.e., higher-profile, than some other transceiver module types.

### SUMMARY

Embodiments of the present invention relate to an optical communications module having a low-profile arrangement of optical and electronic elements. In an exemplary embodiment, the optical communications module includes a module housing, a printed circuit board (PCB), a device mounting block, at least one opto-electronic device, at least one signal processing integrated circuit (IC), and a top lens device. The opto-electronic device, such as a light source or a light detector, is mounted on the device mounting block in an orientation in which the opto-electronic device optical axis is substantially normal to the PCB. An upper surface of the signal processing IC has an array of electrical signal contacts in electrical contact with a corresponding array of electrical signal pads on the PCB lower surface. The top lens device has a fiber port configured to communicate optical signals with a fiber-optic cable at the forward end of the module housing. The top lens device also has a device port configured to communicate the optical signals with the opto-electronic device. The top lens device has a reflector portion configured to redirect the optical signals at a non-zero angle between the fiber port and the device port. A lower surface of the signal processing IC is coupled to the device mounting block.

Other systems, methods, features, and advantages will be or become apparent to one with skill in the art upon examination of the following figures and detailed description. It is intended that all such additional systems, methods, features, and advantages be included within this description, be within the scope of the specification, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is a perspective view of an optical transceiver module in accordance with an exemplary embodiment of the invention.

FIG. 2 is a top perspective view of a printed circuit board (PCB) of the optical transceiver module of FIG. 1.

FIG. 3 is a bottom perspective view of the PCB.

FIG. 4 is a perspective view illustrating attaching driver and receiver integrated circuits (ICs) to the PCB.

FIG. 5 is a perspective view of the lower side or bottom of the PCB and the attached driver and receiver ICs.

FIG. 6 is a perspective view of the upper side or top of the PCB and the attached driver and receiver ICs.

FIG. 7 is a perspective view of a device mounting block.

FIG. 8 is a perspective view of the device mounting block attached to the PCB.

FIG. 9 is a top plan view of a sub-assembly comprising the PCB and device mounting block, showing the driver and receiver ICs attached to the PCB.

FIG. 10 is a top plan view of the sub-assembly of FIG. 9, further including a transmitter opto-electronic light source, a receiver opto-electronic light detector, and a monitor opto-electronic light detector.

FIG. 11 is a top plan view of the sub-assembly of FIG. 10, further including a transmit bottom lens device and a receive bottom lens device.

FIG. 12 is a perspective view illustrating attaching a top lens device to the sub-assembly of FIG. 11.

FIG. 13 is a perspective view of the electro-optical sub-assembly, including the attached top lens device.

FIG. 14 is a perspective view of the lower side or bottom of the top lens device.

FIG. 15 is a sectional view taken on line 15-15 of FIG. 13.

### DETAILED DESCRIPTION

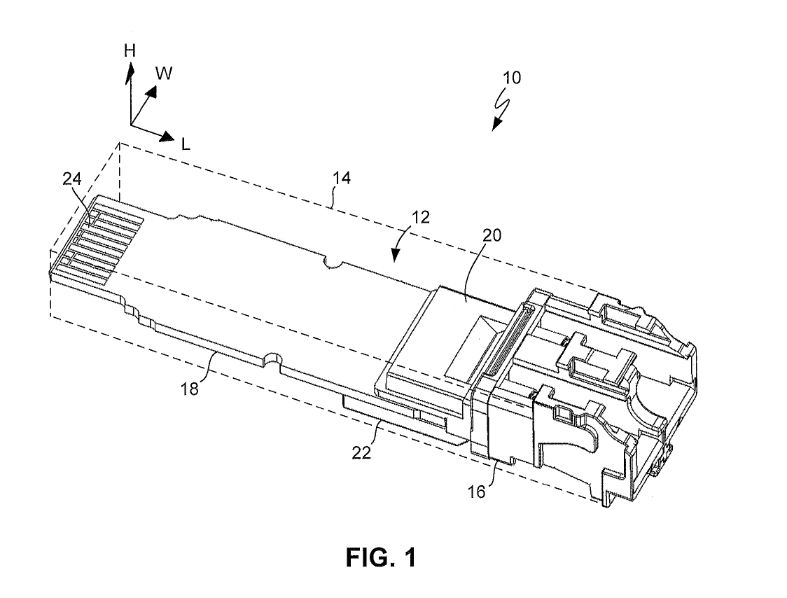

As illustrated in FIG. 1, in a first illustrative or exemplary embodiment of the invention, an optical communications module 10 includes an electro-optical sub-assembly 12. Electro-optical sub-assembly 12 is essentially contained within a module housing 14. Only the housing nose 16 of module housing 14 is shown in detail for purposes of clarity, the remainder of module housing 14 being indicated in generalized form in broken line. However, module housing 14, including housing nose 16, can have a generally SFP configuration. That is, housing 14 can conform to any of the SFP family of module configurations, such as, for example, SFP+. Accordingly, housing nose 16 is configured to mate with a conventional LC optical fiber cable (not shown). Although not shown for purposes of clarity, a delatch mechanism can be coupled to housing node 16 in accordance with conventional SFP configurations. As such delatch mechanism and housing configurations are well understood by persons skilled in the art, they are not described in detail herein. The rearward end of optical communications module 10 can be plugged into a receptacle of a conventional external device (not shown), such as, for example, a data communications switch, in a conventional manner.

Note in FIG. 1 that optical communications module 10 is shown with respect to a three-dimensional frame of reference having length (L), width (W) and height (H) dimensions. Optical communications module 10 is elongated in the length dimension between its forward end rearward ends. The height dimension is relevant to the low-profile characteristic described below.

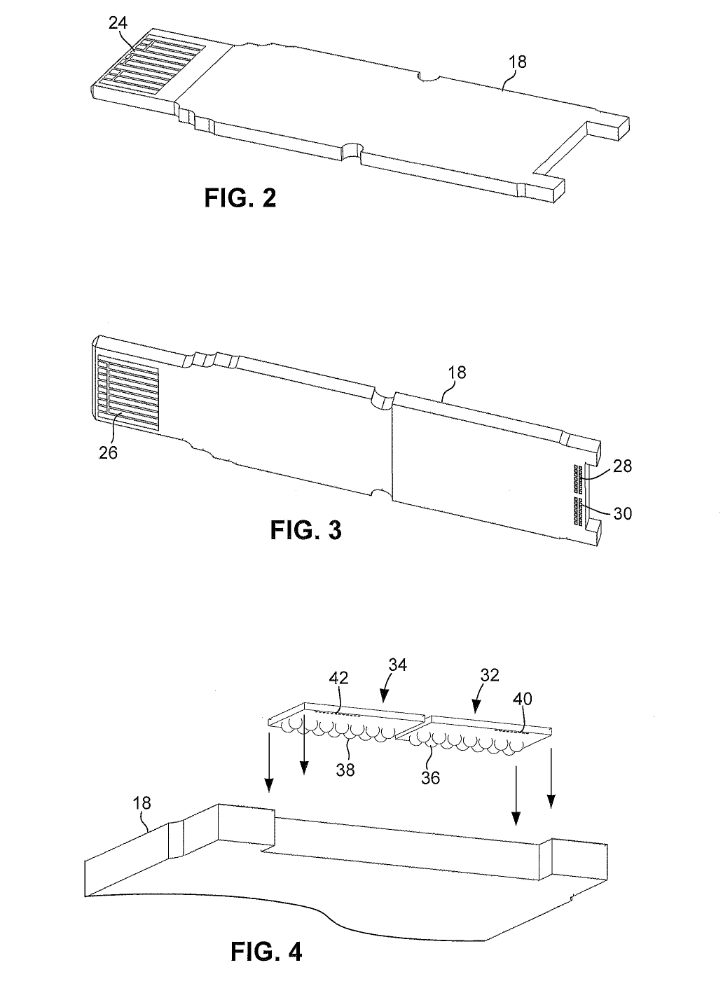

Electro-optical sub-assembly 12 includes an elongated printed circuit board (PCB) 18, a top lens device 20, and a device mounting block 22. As further illustrated in FIG. 2, a first plurality of electrical contact pads 24 are arrayed on the upper surface of PCB 18 at the rearward end of PCB 18 (which substantially coincides with the rearward end of optical communications module 10). Similarly, as illustrated in FIG. 3, a second plurality of electrical contact pads 26 are arrayed on the lower surface of PCB 18 at the rearward end of optical communications module 10. At its forward end, the lower surface of PCB 18 has a third plurality of electrical contact pads 28 and a fourth plurality of electrical contact pads 30. Although not shown for purposes of clarity in FIGS. 1-3, integrated circuit packages and other electronic devices can be mounted on the surfaces of PCB 18. Although also not shown for purposes of clarity, PCB 18 includes circuit traces for interconnecting such electronic devices with electrical contact pads 24-30 and other opto-electronic and electronic elements described below. As well understood by persons skilled in the art, electrical contact pads 24-30 are metallized regions similar to PCB circuit traces.

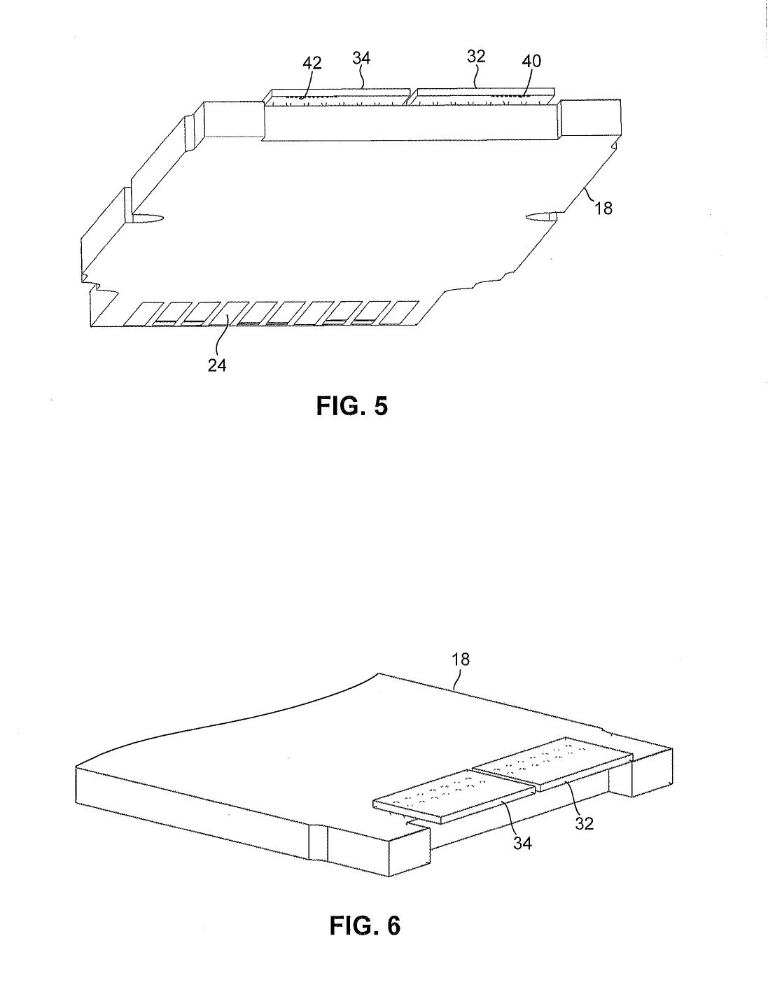

As illustrated in FIG. 4, signal processing integrated circuits (ICs), namely, a driver IC 32 and a receiver IC 34, are mounted against the lower surface of PCB 18. Driver IC 32 and receiver IC 34 include ball grid arrays (BGAs) 36 and 38, respectively, or similar arrays of electrical signal contacts. BGAs 36 and 38 are soldered to the third and fourth pluralities of electrical contact pads 28 and 30, respectively, thereby electrically connecting driver IC 32 and receiver IC 34 with electrical signal interconnections (i.e., circuit traces) of PCB 18. The surfaces of driver IC 32 and receiver IC 34 having BGAs 36 and 38 are referred to herein as the upper surfaces of driver IC 32 and receiver IC 34. The upper surfaces of driver IC 32 receiver IC 34 also have arrays of electrical contacts 40 and 42, respectively. Note in FIGS. 5-6 that the portions of driver IC 32 and receiver IC 34 having the arrays of electrical contacts 40 and 42 overhang the forward edge of PCB 18, while the portions of driver IC 32 and receiver IC 34 having BGAs 36 and 38 are mounted against the lower surface of PCB 18.

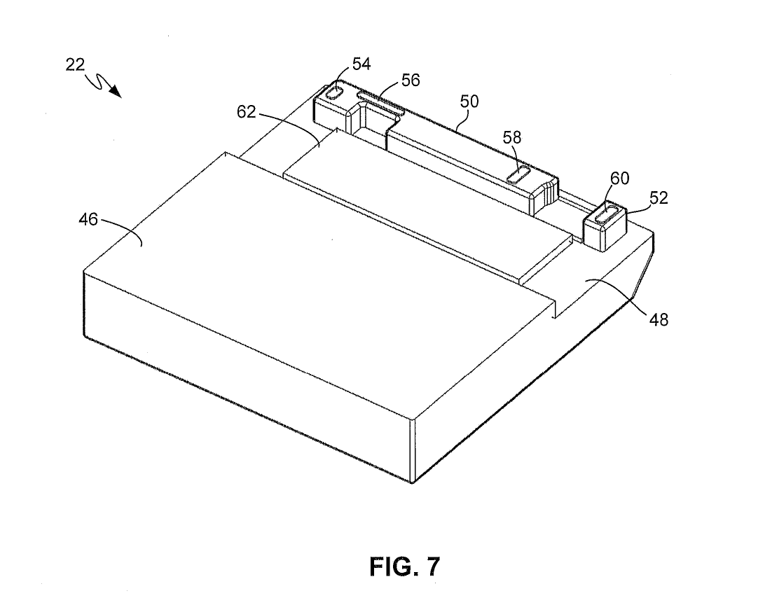

As illustrated in FIG. 7, device mounting block 22 can consist of cast metal, such as copper, which acts as a heat sink to aid conveying excess heat to module housing 14 (FIG. 1). Device mounting block 22 has a substantially planar attachment surface 46 and a recessed surface 48 that is recessed (in the height direction) within device mounting block 22 with respect to attachment surface 46. The height direction describes not only the distance between attachment surface 46 and recessed surface 48 but also, for example, the thickness of PCB 18. In the exemplary embodiment, recessed surface 48 is also substantially planar and is parallel to substantially planar attachment surface 46.

Device mounting block 22 has standoff portions 50 and 52 that extend above, i.e., in the height direction, recessed region 48. Standoff portion 50 has lens mounting pads or regions 54, 56 and 58. Standoff portion 52 similarly has a lens mounting pad or region 60. A thermally conductive pad 62 is attached to recessed surface 48.

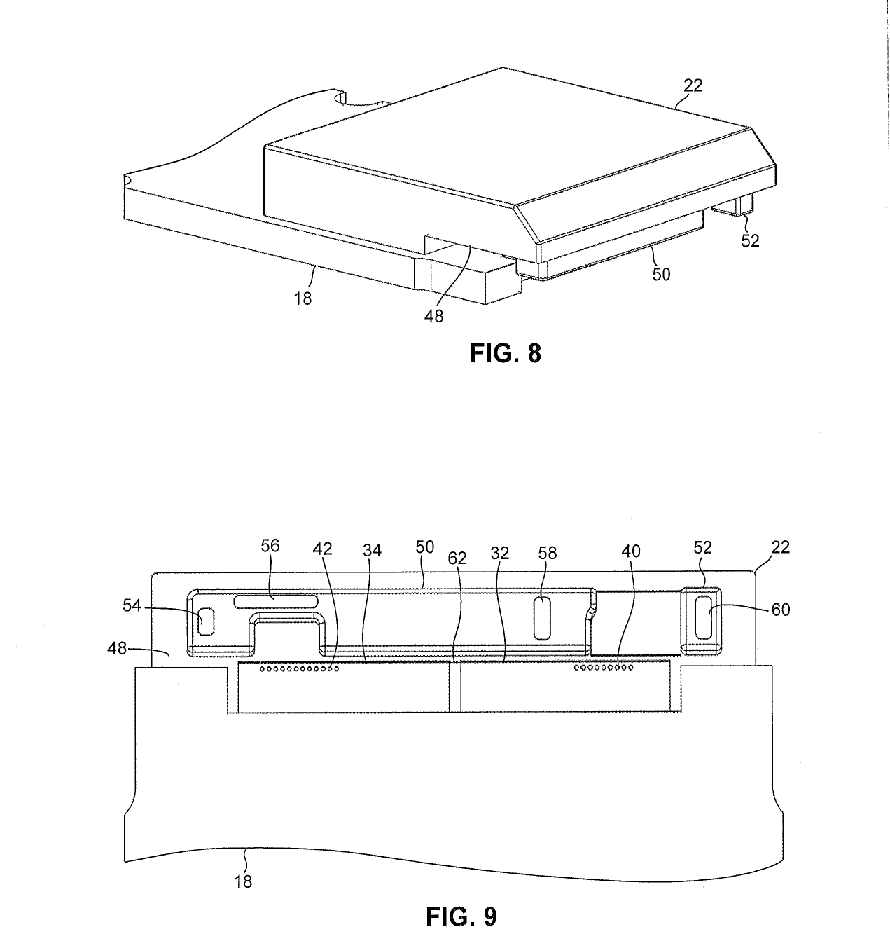

As illustrated in FIGS. 8-9, device mounting block 22 is attached to PCB 18 in an orientation in which attachment surface 46 of device mounting block 22 adjoins and is in contact with the lower surface of PCB 18. Note that the lower surfaces of driver IC 32 and receiver IC 34 are coupled to recessed surface 48 of device mounting block 22 (via thermally conductive pad 62).

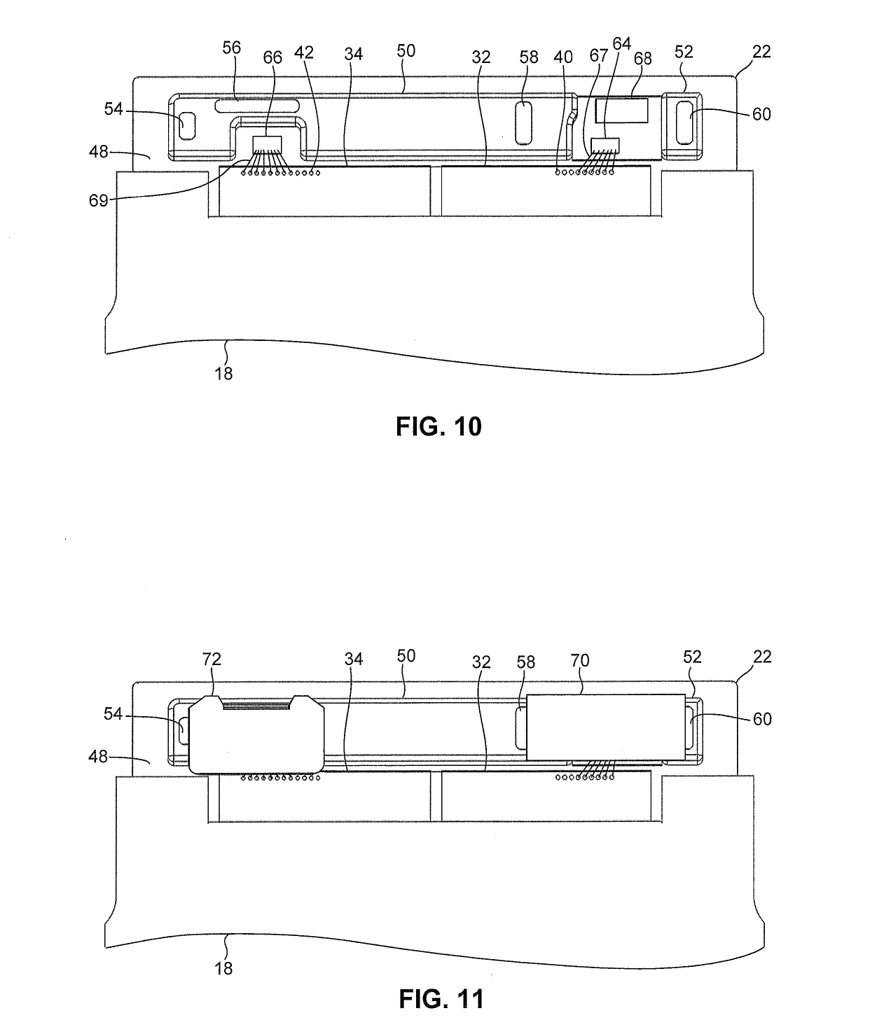

As illustrated in FIG. 10, a transmitter opto-electronic light source 64 is mounted on recessed surface 48 of device mounting block 22. Transmitter opto-electronic light source 64 can be, for example, a vertical cavity surface-emitting laser (VCSEL) chip with one or more laser elements (not individually shown for purposes of clarity). In operation, the laser element emits a light beam, i.e., optical transmit signals, along an optical axis normal to recessed surface 48. A receiver opto-electronic light detector 66 is also mounted on recessed surface 48. Receiver opto-electronic light detector 66 can be, for example, a PIN photodiode chip with one or more photodiode elements (not individually shown for purposes of clarity). In operation, the photodiode element detects a light beam, i.e., optical receive signals, along an optical axis normal to recessed surface 48. Transmitter opto-electronic light source 64 and receiver opto-electronic light detector 66 can be die-attached to recessed surface 48 to promote heat transfer into device mounting block 22. A monitor opto-electronic light detector 68 similarly can be mounted on recessed surface 48. In operation, monitor opto-electronic light detector 68 detects a portion of the light beam emitted by transmitter opto-electronic light source 64 and, in response, provides a corresponding feedback signal to driver IC 32. A plurality of wirebonds 67 electrically connect transmitter opto-electronic light source 64 to the array of electrical contacts 40 on the upper surface of driver IC 32. Likewise, another plurality of wirebonds 69 electrically connect receiver opto-electronic light detector 66 to the array of electrical contacts 42 on the upper surface of receiver IC 34.

As illustrated in FIG. 11, a transmit bottom lens device 70 and a receive bottom lens device 72 are mounted over transmitter opto-electronic light source 64 and receiver opto-electronic light detector 66, respectively. More specifically, the lower surface of transmit bottom lens device 70 is mounted on lens mounting regions 54 and 56 (FIG. 10), and the lower surface of receive bottom lens device is mounted on lens mounting regions 58 and 60. In the exemplary embodiment, each of transmit bottom lens device 70 and receive bottom lens device 72 consists of a generally brick-shaped mass or block of optically transparent material, such as, for example, ULTEM (amorphous thermoplastic polyetherimide, available from SABIC Innovative Plastics of Saudi Arabia), glass, etc. (For purposes of clarity, the transparency of bottom lens devices 70 and 72 is not depicted.) Although not shown for purposes of clarity, each of transmit bottom lens device 70 and receive bottom lens device 72 has one or more refractive or diffractive lenses formed in its upper or lower surfaces. Transmit bottom lens device 70 and receive bottom lens device 72 can be formed by molding ULTEM or other moldable material, photolithography on glass, or other suitable methods.

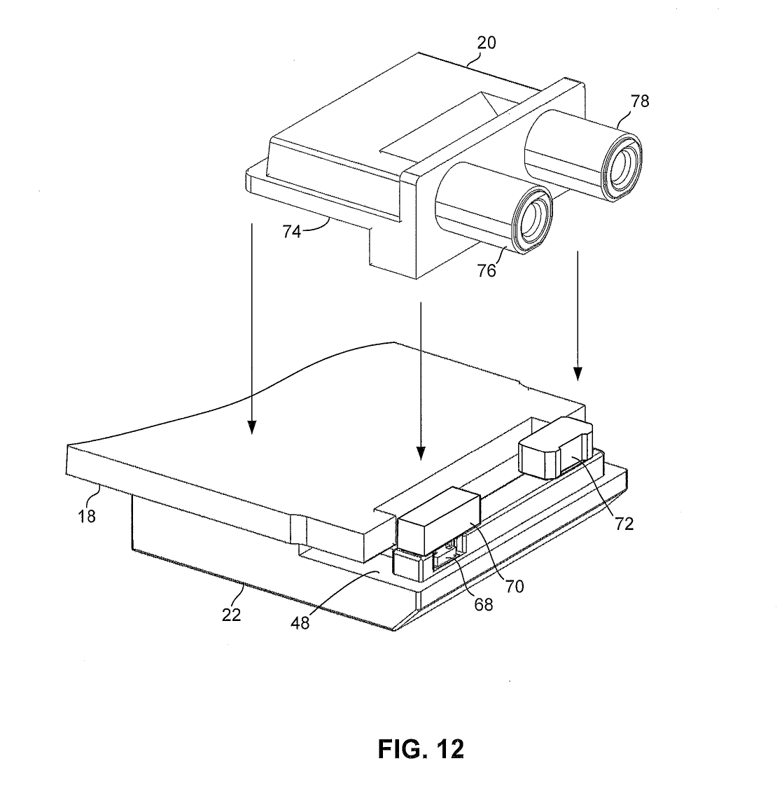

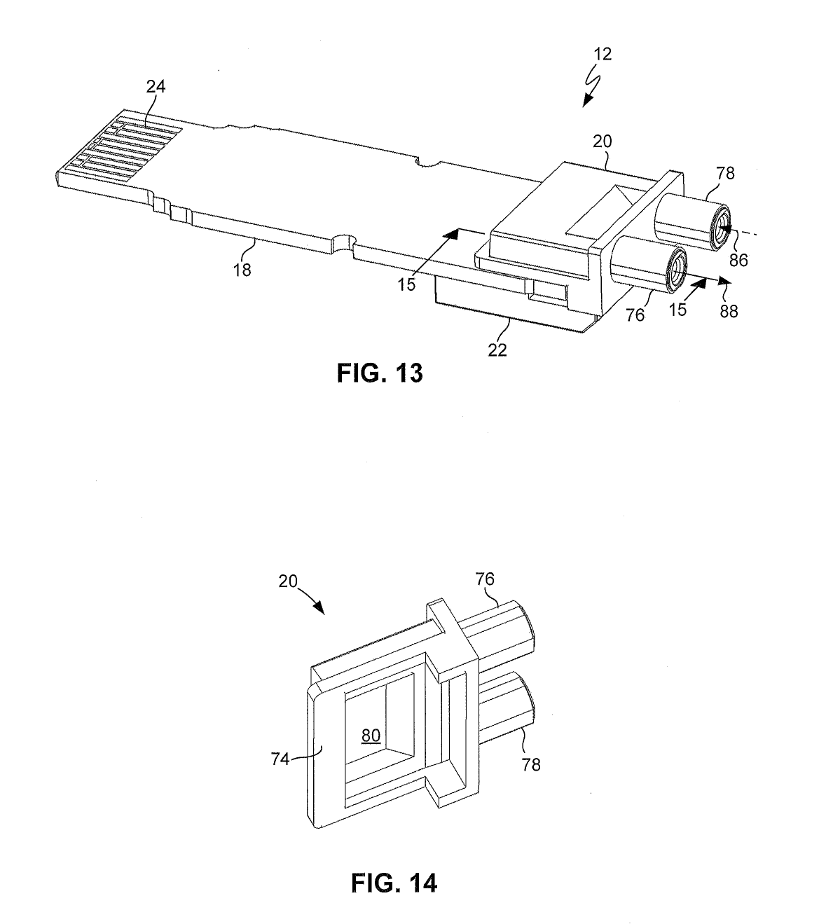

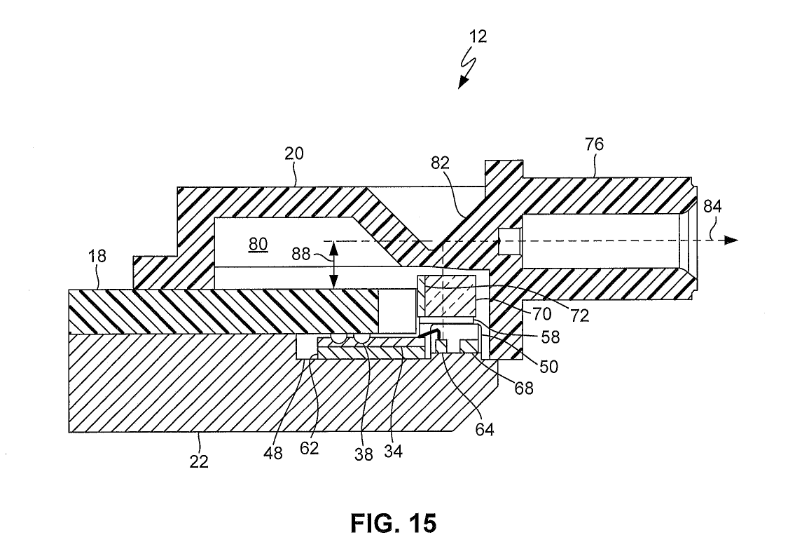

As illustrated in FIGS. 12-13, top lens device 20 is mounted on PCB 18, with a lower surface 74 of top lens device 20 contacting the upper surface of PCB 18. Note that top lens device 20 is mounted over bottom lens devices 70 and 72. Top lens device 20 can consist of a molded plastic material, such as ULTEM, which is optically transparent to the wavelengths of the signals transmitted and received by optical communications module 10. In the exemplary embodiment, top lens device 20 has a transmit LC port 76 and a receive LC port 78 that are mateable with LC fiber-optic cable connectors (not shown) when such connectors are plugged into housing nose 16 (FIG. 1). As further illustrated in FIGS. 14-15, the underside or lower portion of top lens device 20 has a cavity 80. A reflective surface 82 (FIG. 15) formed in a wall of top lens device 20 reflects the optical signals in the manner described below.

As illustrated in FIG. 15, in operation transmitter opto-electronic light source 64 emits the transmit optical signals (i.e., a light beam) in response to electrical signals it receives via electronic circuitry comprising driver IC 32 and circuit traces of PCB 18. That is, transmitter opto-electronic light source 64 converts the electrical signals into optical signals. This electronic circuitry is coupled to the electrical contact pads 24 and 26 at the rearward end of PCB 18 (FIGS. 1-3), which thus can receive corresponding electronic signals from an external system (not shown) into which optical communications device 10 is plugged. Transmit bottom lens device 70 substantially collimates the transmit optical signals, which in turn impinge upon reflective surface 82. Reflective surface 82 redirects the transmit optical signals at an angle of substantially 90 degrees into transmit LC port 76. In FIG. 15, the transmit optical path 84 along which the transmit optical signals propagate in the above-described manner is indicated by a broken-line arrow. Another optical path in which transmit bottom lens device 70 reflects a portion of the transmit optical signals onto monitor opto-electronic light detector 68 is not shown for purposes of clarity.

Note that a space or air gap exists in cavity 80 between the top of transmit bottom lens device 70 and the interior wall of top lens device 20. That is, transmit bottom lens device 70 extends into cavity 80 but does not contact any portion of top lens device 20. Although not shown in FIG. 15, receive bottom lens device 72 is similarly spaced apart from top lens device 20 by a gap. Note that it may be desirable to fix the distance 88 (in the height dimension) between PCB 18 and LC ports 76 and 78 in accordance with industry standards, such as the Fiber Optic Connector Intermateability Standard (FOCIS) promulgated by the Fiber Optic Association, Inc., or for other reasons. But for the inclusion of features described above, the separation of top lens device 20 and bottom lens devices 70 and 72 could hamper providing a sufficiently small distance 88 that may be required by a standard or otherwise desired. That is, the features described above promote minimization of distance 88, thereby contributing a low-profile characteristic to electro-optical sub-assembly 12. Note, for example, that PCB 18 and bottom lens devices 70 and 72 are at roughly similar heights, such that the plane of the upper surface of PCB 18 intersects bottom lens devices 70 and 72.

The receive optical signals entering receive LC port 78 along a receive optical path 86 (FIG. 13) impinge upon reflective surface 82, which redirects the receive optical signals at an angle of substantially 90 degrees into receive bottom lens device 72. Receive bottom lens device 72 focuses the receive optical signals onto opto-electronic light detector 66. Although receive optical path 86 is not shown in the cross-sectional view of FIG. 15, it can be noted that receive optical path 86 is similar to above-described transmit optical path 84. In response to the receive optical signals, opto-electronic light detector 66 produces electrical signals, which are provided to electronic circuitry comprising receiver IC 34 and circuit traces of PCB 18. That is, opto-electronic light detector 66 converts the receive optical signals into electrical signals. The plurality of electrical contact pads 24-26 can output corresponding electronic signals to an external system (not shown) into which optical communications device 10 is plugged.

In operation, thermally conductive pad 62 conducts heat generated by driver IC 32 and receiver IC 34 into device mounting block 22, as the upper surface of thermally conductive pad 62 contacts the lower surfaces of driver IC 32 and receiver IC 34 while the lower surface of thermally conductive pad 62 contacts recessed surface 48 of device mounting block 22.

One or more illustrative embodiments of the invention have been described above. However, it is to be understood that the invention is defined by the appended claims and is not limited to the specific embodiments described.

What is claimed is:

1. An optical communications module, comprising:
a module housing having a forward end coupleable to a fiber-optic cable;
a printed circuit board (PCB) having a PCB lower surface and a PCB upper surface;
a device mounting block attached to the PCB;
an opto-electronic device mounted on the device mounting block, the opto-electronic device having an optical axis substantially normal to the PCB;
a signal processing integrated circuit (IC) having an IC lower surface adjoining the device mounting block and an IC upper surface having an array of electrical signal contacts in electrical contact with a corresponding array of electrical signal pads on the PCB lower surface; and
a top lens device having a fiber port configured to communicate optical signals with the fiber-optic cable and a device port configured to communicate the optical signals with the opto-electronic device, the top lens device having a reflector portion configured to redirect the optical signals at a non-zero angle between the fiber port and the device port.

2. The optical communications module of claim 1, wherein array of electrical signal contacts comprises a ball grid array (BGA).

3. The optical communications module of claim 1, wherein the opto-electronic device is mounted on a side of the device mounting block adjoining the PCB lower surface.

4. The optical communications module of claim 1, wherein a side of the device mounting block adjoining the PCB lower surface has an attachment surface in contact with the PCB lower surface and a recessed portion recessed into the device mounting block with respect to the attachment surface, and the IC lower surface is coupled to the recessed portion of the device mounting block.

5. The optical communications module of claim 4, wherein a thermally conductive pad couples the IC lower surface and the recessed portion of the device mounting block.

6. The optical communications module of claim 1, wherein the reflector portion is configured to redirect the optical signals at an angle of substantially 90 degrees between the fiber port and the device port

7. The optical communications module of claim 1, wherein the device mounting block consists of metal, and the opto-electronic device is die-attached to the device mounting block.

8. The optical communications module of claim 1, wherein a plurality of wirebonds electrically couple signals between the opto-electronic device and the signal processing IC.

9. The optical communications module of claim 8, wherein the wirebonds are attached to the IC upper surface.

10. The optical communications module of claim 1, further comprising a bottom lens device mounted over the opto-electronic device along the optical axis.

11. The optical communications module of claim 10, wherein the bottom lens device is mounted to the device mounting block.

12. The optical communications module of claim 1, wherein:
the opto-electronic device comprises a light source device and a light detector device; and
the bottom lens device comprises a transmit bottom lens device mounted over the light source device and a receive bottom lens device mounted over the light detector device.

13. The optical communications module of claim 1, wherein the top lens device consists of optically transparent plastic material.

14. The optical communications module of claim 1, wherein the bottom lens device extends into a cavity in the top lens device.

15. The optical communications module of claim 1, wherein a lower surface of the top lens device defines a generally planar region and contacts the PCB upper surface.

16. An optical communications module, comprising:
a module housing having a forward end coupleable to a fiber-optic cable;
a printed circuit board (PCB) having a PCB lower surface and a PCB upper surface;
a device mounting block attached to the PCB;
an opto-electronic device mounted on the device mounting block, the opto-electronic device having an optical axis normal to the PCB;
a signal processing integrated circuit (IC) having an IC lower surface adjoining the device mounting block and an IC upper surface having a ball grid array (BGA) in electrical contact with a corresponding array of electrical signal pads on the PCB lower surface;
a bottom lens device mounted over the opto-electronic device along the optical axis;
a top lens device having a fiber port configured to communicate optical signals with the fiber-optic cable and a device port configured to communicate the optical signals with the opto-electronic device, the top lens device having a reflector portion configured to redirect the optical signals at an angle of substantially 90 degrees between the fiber port and the device port.

17. The optical communications module of claim 16, wherein:
the opto-electronic device is mounted on a side of the device mounting block adjoining the PCB lower surface; and
the side of the device mounting block adjoining the PCB lower surface has an attachment surface in contact with the PCB lower surface and a recessed portion recessed into the device mounting block with respect to the attachment surface; and
the IC lower surface is coupled to the recessed portion of the device mounting block.

18. The optical communications module of claim 16, wherein a plurality of wirebonds attached to the IC upper surface electrically couple signals between the opto-electronic device and the signal processing IC.

19. The optical communications module of claim 18, wherein:
the bottom lens device is mounted to the device mounting block; and
the plurality of wirebonds extend through a region between the bottom lens device and the opto-electronic device.

20. The optical communications module of claim 19, wherein a plane through the PCB parallel to the PCB upper and lower surfaces intersects the bottom lens device.
